(19) United States
(12) Patent Application Publication
(10) Pub. No.: US 2010/0071655 A1
(43) Pub. Date: Mar. 25, 2010

(54) Fuel Pump Lubrication Apparatus Driven by Cam

(75) Inventor: Kyounghee KIM, Ansan-city (KR)

Correspondence Address: MORGAN, LEWIS & BOCKIUS LLP (SF), One Market, Spear Street Tower, Suite 2800, San Francisco, CA, 94105, US

(73) Assignees: Hyundai Motor Company, Seoul (KR); Kia Motors Corporation, Seoul (KR)

(21) Appl. No.: 12/563,910

(22) Filed: Sep. 21, 2009

(30) Foreign Application Priority Data
Sep. 25, 2008 (KR) 10-2008-0094105

(51) Int. Cl. F01M 1/02; F16N 13/02

(52) U.S. Cl. 123/196 R; 184/32

(57) ABSTRACT

A fuel pump lubrication apparatus, which lubricates a tappet driven by a fuel pump and moving reciprocally in an interior circumference of a fuel pump adaptor, the apparatus may include a cylinder head that is provided with a camshaft and an oil gallery connected to an oil pump, and an oil supplying line communicated with the oil gallery so as to supply oil of the oil pump to the inside of the fuel pump adaptor, wherein the oil supplying line includes a tappet lubrication nozzle and a cam lubrication nozzle formed at an end thereof.

### CROSS-REFERENCE TO RELATED APPLICATION

The present application claims priority to Korean Patent Application No. 10-2008-0094105 filed on Sep. 25, 2008, the entire contents of which are incorporated herein for all purposes by this reference.

### BACKGROUND OF THE INVENTION

1. Field of the Invention

This present invention relates to a lubrication structure of an engine, and more particularly to a fuel pump lubrication device that is capable of effectively lubricating a tappet of the engine, a tappet roller, and a cam.

2. Description of Related Art

Technologies for a gasoline direct injection (GDI) engine have been studied in order to improve fuel consumption and performance of the engine.

The GDI engine technologies are methods in which only air is drawn into the combustion chamber and is compressed and then fuel is injected therein, while in the case of a conventional gasoline engine, power is generated in a period of an intake stroke, a compression stroke, an ignition stroke, and an exhaust stroke process of an air/fuel mixture.

Such a method is similar to a compressed ignition engine method.

Due to a high compression ratio of the GDI engine, a high compression ratio that is capable of exceeding a limit of a usual gasoline engine results in maximization of fuel consumption.

The GDI engine depends on a high fuel pressure, and a high performance fuel pump is required.

The fuel pump is mechanically driven by a cam so as to operate a tappet, and friction inside the fuel pump is generated.

A great deal of friction occurs in the fuel pump due to the high pressure of the fuel.

Therefore, a lubrication device of the fuel pump for compressing the fuel in the GDI engine has been studied in order to improve durability and performance of the GDI engine.

To solve the problems, as an example, a method of lubricating the cam with oil stored in a predetermined space when a camshaft for the fuel pump is rotated is used.

Such a method has a merit of simplifying the structure, but it is difficult to lubricate throughout the fuel pump, and it is difficult to lubricate it at a slanted surface.

Further, there is a method, as another example, which forms an oil hole at the cam so as to flow oil therein.

However, the method mentioned above has a drawback in that it is capable of lubricating only a specific part that is provided with an oil hole, and it is impossible to form a hole at a portion of the cam contacting the tappet of the fuel pump.

In addition, the cam rotates in such a state in which it rotatably contacts the roller mounted at the bottom of the cam so as to operate the tappet upwardly and downwardly, and the conventional tappet lubrication structure of the engine guides the tappet upwardly and downwardly by the roller between the tappet and the cam, but contact surfaces between the tappet and the fuel pump adaptor and between the cam and the roller are not lubricated smoothly thereby inducing abrasion, and consequently durability and rotation thereof are deteriorated.

Therefore, due to the abrasion occurring at the roller interposed between the cam and the roller tappet, durability thereof is deteriorated and thereby manufacturing cost is increased, and noise occurs at the connected portion thereof.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a fuel pump lubrication apparatus driven by a cam having advantages of simultaneously lubricating a contacting portion between a tappet and a roller, and the roller and the cam.

In an aspect of the present invention, the fuel pump lubrication apparatus, which lubricates a tappet driven by a fuel pump and moving reciprocally in an interior circumference of a fuel pump adaptor, may include a cylinder head that is provided with a camshaft and an oil gallery connected to an oil pump, and an oil supplying line communicated with the oil gallery so as to supply oil of the oil pump to the inside of the fuel pump adaptor, wherein the oil supplying line includes a tappet lubrication nozzle and a cam lubrication nozzle formed at an end thereof.

The tappet lubrication nozzle and the cam lubrication nozzle may be integrally formed between the interior circumference and an outer circumference of the fuel pump adaptor.

The oil supplying line may includes, a first oil passage supplying the oil received from the oil gallery to a cam journal supporting a cam, a second oil passage supplying the oil having passed through the first oil passage to the cylinder head, a cam cap, and a cam carrier, and a third oil passage supplying the oil having passed through the second oil passage to the inside of the fuel pump adaptor through the tappet lubrication nozzle and the cam lubrication nozzle.

The tappet lubrication nozzle and the cam lubrication nozzle may be integrally formed between the interior circumference and an outer circumference of the fuel pump adaptor.

The tappet lubrication nozzle may be connected to the third oil passage and supplies the oil having passed through the third oil passage to a contacting portion between the interior circumference of the fuel pump adaptor and the tappet and/or a contacting portion between the tappet and the cam.

The cam lubrication nozzle may be branched from the tappet lubrication nozzle and supplies the oil having passed through the third oil passage to a contacting portion between the tappet and the cam.

The oil supplying passage may be configured to supply the oil received from the oil pump to the fuel pump of a GDI engine.

In another aspect of the present invention, the fuel pump lubrication apparatus, which lubricates a tappet driven by a fuel pump and moving reciprocally in an interior circumference of a fuel pump adaptor, may include a cylinder head that is provided with a camshaft and an oil gallery connected to an oil pump, and an oil supplying line communicated with the oil gallery so as to supply oil of the oil pump to the inside of the fuel pump adaptor, wherein the oil supplying line includes a tappet lubrication nozzle supplying the oil received from the oil pump to a contacting portion between the fuel pump adaptor and the tappet and/or a contacting portion between the tappet and a cam, and a cam lubrication nozzle supplying the oil received from the oil pump to a contacting portion between the tappet and the cam.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a cross-sectional view of a main portion of a fuel pump lubrication apparatus driven by a cam according to an exemplary embodiment of the present invention.

FIG. 2 is a perspective view of a cylinder head applied to a fuel pump lubrication apparatus driven by a cam according to an exemplary embodiment of the present invention.

And FIG. 3 is a perspective view of a main portion of a cylinder head applied to a fuel pump lubrication apparatus driven by a cam according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

An exemplary embodiment of the present invention will be hereinafter described in detail with reference to the accompanying drawings.

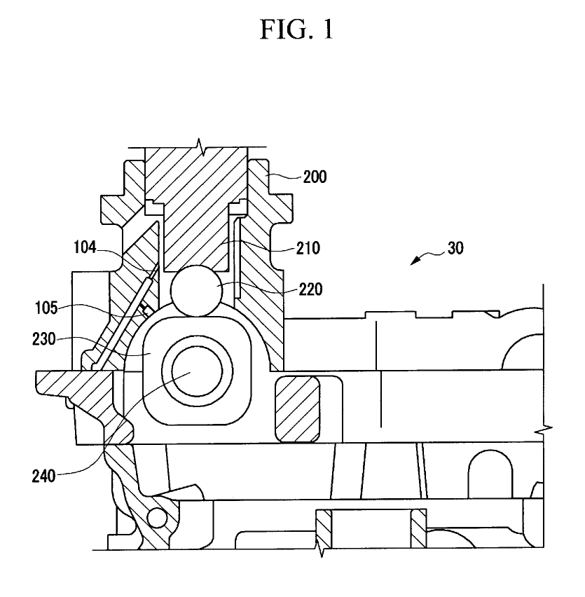

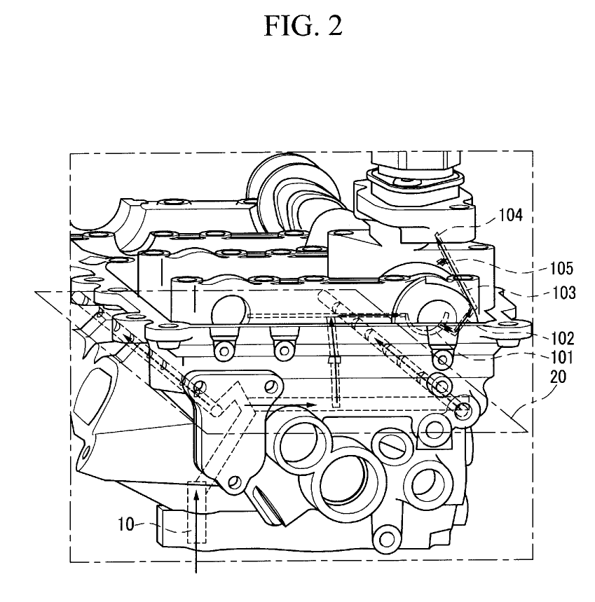

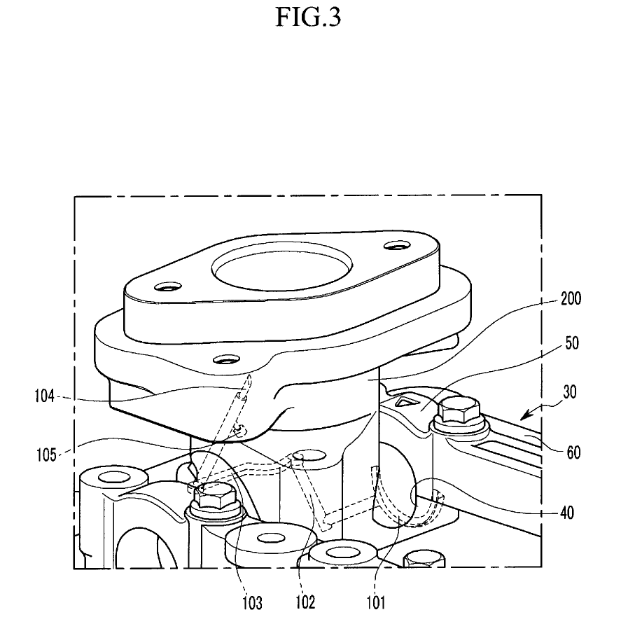

FIG. 1 is a cross-sectional view of a main portion of a fuel pump lubrication apparatus driven by a cam according to an exemplary embodiment of the present invention, and FIG. 2 is a schematic view of a cylinder head applied to a fuel pump lubrication apparatus driven by a cam according to an exemplary embodiment of the present invention.

As shown in FIG. 1 through FIG. 3, a fuel pump lubrication apparatus driven by a cam according to an exemplary embodiment of the present invention includes a main oil gallery 10 formed inside a cylinder head 30, and an oil supplying line 20.

Further, oil injected from an oil pump passes through the main oil gallery 10, and it is supplied to a high pressure pump adaptor 200 through the oil supplying line 20 so as to lubricate and cool the high pressure pump adaptor 200.

The oil supplying line 20 includes a first oil passage 101, a second oil passage 102, and a third oil passage 103.

Among them, the first oil passage 101 is formed such that it can supply the oil to a cam journal 40 supporting a lower portion of a cam shaft 240 and it can encompass an exterior circumference of a lower portion of the camshaft 240.

In this case, the second oil passage 102 is formed such that it is branched from the first oil passage 101 in the cylinder head 30, and the oil having passed through the first oil passage 101 is supplied to a cam cap 50 or a cam carrier 60 through the second oil passage 102 formed inside the cylinder head 30.

Further, the third oil passage 103 is communicated with the second oil passage 102, and the third oil passage 103 is formed upwardly such that the oil having passed through the second oil passage 102 is supplied to the high pressure pump adaptor 200.

A tappet lubrication nozzle 104 and a cam lubrication nozzle 105 are branched from an end of the third oil passage 103.

That is, the tappet lubrication nozzle 104 is formed such that it supplies the oil to a tappet 210 mounted inside the high pressure pump adaptor 200, and to a portion between a roller 220 disposed at the bottom of the tappet 210 and a cam 230 rotating frictionally therewith.

At the same time, an end portion of the tappet lubrication nozzle 104 is formed such that it is slanted from the lower side to the upper side, so a lateral portion of the tappet is lubricated.

Therefore, the oil injected from the tappet lubrication nozzle lubricates the portion between the roller 220 and the cam 230 with its own weight.

Meanwhile, the cam lubrication nozzle 105 is formed such that it can supply the oil to a contacting portion between the cam 230 and the roller 220.

The cam lubrication nozzle 105 may preferably be formed so that it is slanted downwardly toward the cam 230, and thereby the oil is supplied to an exterior circumference of the roller 220 by the cam lubrication nozzle 105 so as to form a lubricant film thereon.

As a result, friction generated between the tappet 210 and the roller 220 is reduced, so abrasion of the lower surface of the tappet 210 is prevented.

Therefore, a fuel pump lubrication apparatus driven by a cam according to an exemplary embodiment of the present invention reduces friction and also reduces abrasion or noise generated by the friction by simultaneously lubricating contact portions between the tappet 210 and the roller 220, and the roller 220 and the cam 230.

For convenience in explanation and accurate definition in the appended claims, the terms “upper”, “lower”, and “bottom” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A fuel pump lubrication apparatus, which lubricates a tappet driven by a fuel pump and moving reciprocally in an interior circumference of a fuel pump adaptor, the apparatus comprising:
a cylinder head that is provided with a camshaft and an oil gallery connected to an oil pump; and
an oil supplying line communicated with the oil gallery so as to supply oil of the oil pump to the inside of the fuel pump adaptor,
wherein the oil supplying line includes a tappet lubrication nozzle and a cam lubrication nozzle formed at an end thereof.

2. The apparatus of claim 1, wherein the tappet lubrication nozzle and the cam lubrication nozzle are integrally formed between the interior circumference and an outer circumference of the fuel pump adaptor.

3. The apparatus of claim 1, wherein the oil supplying line includes:
a first oil passage supplying the oil received from the oil gallery to a cam journal supporting a cam;
a second oil passage supplying the oil having passed through the first oil passage to the cylinder head, a cam cap, and a cam carrier; and
a third oil passage supplying the oil having passed through the second oil passage to the inside of the fuel pump adaptor through the tappet lubrication nozzle and the cam lubrication nozzle.

4. The apparatus of claim 3, wherein the tappet lubrication nozzle and the cam lubrication nozzle are integrally formed between the interior circumference and an outer circumference of the fuel pump adaptor.

5. The apparatus of claim 3, wherein the tappet lubrication nozzle is connected to the third oil passage and supplies the oil having passed through the third oil passage to a contacting portion between the interior circumference of the fuel pump adaptor and the tappet and/or a contacting portion between the tappet and the cam.

6. The apparatus of claim 5, wherein the cam lubrication nozzle is branched from the tappet lubrication nozzle and supplies the oil having passed through the third oil passage to a contacting portion between the tappet and the cam.

7. The apparatus of claim 6, wherein the tappet lubrication nozzle and the cam lubrication nozzle are formed to be slanted upwardly and downwardly respectively to form a predetermined angle therebetween.

8. The apparatus of claim 1, wherein the tappet lubrication nozzle supplies the oil received from the oil pump to a contacting portion between the interior circumference of the fuel pump adaptor and the tappet and/or a contacting portion between the tappet and a cam.

9. The apparatus of claim 1, wherein the cam lubrication nozzle supplies the oil received from the oil pump to a contacting portion between the tappet and a cam.

10. The apparatus of claim 1, wherein the tappet lubrication nozzle and the cam lubrication nozzle are formed to be slanted upwardly and downwardly respectively to form a predetermined angle therebetween.

11. The apparatus of claim 1, wherein the oil supplying passage is configured to supply the oil received from the oil pump to the fuel pump of a GDI engine.

12. A fuel pump lubrication apparatus, which lubricates a tappet driven by a fuel pump and moving reciprocally in an interior circumference of a fuel pump adaptor, the apparatus comprising:
a cylinder head that is provided with a camshaft and an oil gallery connected to an oil pump; and
an oil supplying line communicated with the oil gallery so as to supply oil of the oil pump to the inside of the fuel pump adaptor,
wherein the oil supplying line includes a tappet lubrication nozzle supplying the oil received from the oil pump to a contacting portion between the fuel pump adaptor and the tappet and/or a contacting portion between the tappet and a cam, and a cam lubrication nozzle supplying the oil received from the oil pump to a contacting portion between the tappet and the cam.

13. The apparatus of claim 12, wherein the oil supplying passage comprises:
a first oil passage supplying the oil received from the oil gallery to a cam journal supporting the cam;
a second oil passage supplying the oil having passed through the first oil passage to the cylinder head, a cam cap, and a cam carrier; and
a third oil passage supplying the oil having passed through the second oil passage to the inside of the fuel pump adaptor through the tappet lubrication nozzle and the cam lubrication nozzle.

14. The apparatus of claim 12, wherein the tappet lubrication nozzle and the cam lubrication nozzle are formed to be slanted upwardly and downwardly respectively to form a predetermined angle therebetween.

15. The apparatus of claim 12, wherein the oil supplying passage is configured to supply the oil received from the oil pump to the fuel pump of a GDI engine.
